(19) United States
(12) Patent Application Publication
(10) Pub. No.: US 2016/0086131 A1
(43) Pub. Date: Mar. 24, 2016

(54) STORAGE SYSTEM

(71) Applicant: Warehouse TERRADA, Tokyo (JP)

(72) Inventor: Yoshihisa NAKANO, Tokyo (JP)

(21) Appl. No.: 14/859,719

(22) Filed: Sep. 21, 2015

(30) Foreign Application Priority Data
Sep. 22, 2014 (JP) 2014-192587

(51) Int. Cl. G06Q 10/08; G06Q 30/06

(52) U.S. Cl. CPC G06Q 10/0875; G06Q 30/0645; G06Q 10/0833

(57) ABSTRACT

A storage method includes: transmitting request including usage information relating to use of article from service relay server to warehouse management server; transmitting, from warehouse management server to delivery management device, instruction to deliver one-or-more articles packed by user to warehouse; generating detailed information about one-or-more articles in warehouse management server; storing image data obtained by capturing image of one-or-more articles that have been stored, and detailed information in warehouse management server; service relay server transmitting, to user terminal, image data and detailed information acquired from warehouse management server; requesting affiliate server corresponding to usage information to provide optional service for one-or-more articles that have been stored; in response to request from user terminal, requesting warehouse management server to return one-or-more articles that have been stored to user; and requesting by warehouse management server the delivery management device to return one-or-more articles.

### TECHNICAL FIELD

The present technology relates to a system of storing articles.

### BACKGROUND ART

In ordinary households, for example, there are many items that are used temporarily and items that are not going to be used in the near future and for which it is difficult to find a storage location. There is high demand to store such items long-term outside of the home, depending on housing conditions. In response to such demand, there is a service of providing a rental warehouse.

In the case of an ordinary rental warehouse provision service, the service providing company merely leases a warehouse to a user. The user must manage the articles being stored. Specifically, the user needs to record what kind of articles were stored, and when they were stored. However, such a task is troublesome in the case where a large number of articles are stored.

JP 5578581B discloses a storage system according to which a user can use a user terminal to check an image of articles for which storage has been requested, without going to the warehouse.

Incidentally, many users who request storage of an article wish to do something with the article, such as sell it. For example, if a company has an information system for selling articles but does not have a resource such as a warehouse, it is not easy to undertake the business of a storage service that uses a storage system such as that disclosed in JP 5578581B.

### SUMMARY

In an aspect of the present technology there is provided a storage method including: transmitting, in response to a request from a user terminal, an article storage request including usage information on a usage of an article from a service relay server to a warehouse management server; transmitting, from the warehouse management server to a delivery management device, an instruction to deliver one or more articles packed by a user to a warehouse; generating detailed information about the one or more articles in the warehouse management server; storing image data obtained by capturing an image of the one or more articles that have been stored, and the detailed information in the warehouse management server; the service relay server transmitting, to the user terminal, the image data and the detailed information acquired from the warehouse management server; requesting an affiliate server corresponding to the usage information to provide an optional service for the one or more articles that have been stored; in response to a request from the user terminal, the service relay server requesting the warehouse management server to return the one or more articles that have been stored to the user; and upon receiving the return request, the warehouse management server requesting the delivery management device to return the one or more articles that have been stored to the user.

### BRIEF DESCRIPTION OF THE DRAWINGS

FIG. 1 is a block diagram showing a configuration of a storage system according to an exemplary embodiment.

FIG. 2 is a block diagram showing an overview of a storage management server in the storage system.

FIG. 3 is a flowchart showing a flow of a storage method (a flow from member registration to warehousing of an article) according to an exemplary embodiment.

FIG. 4 is a flowchart showing a flow of a storage method (a flow from article browsing to shipping and delivery of a desired article) according to an exemplary embodiment.

FIG. 5 is a flowchart showing a flow of a service provided by an affiliate company (a flow from member registration to warehousing of an article) in the storage method according to an exemplary embodiment.

FIG. 6 is a flowchart showing a flow of a service provided by an affiliate company (a flow from article browsing to shipping and delivery of a desired item) in the storage method according to an exemplary embodiment.

FIG. 7 is a diagram showing an example of output to a user terminal in the storage system according to an embodiment.

FIG. 8 is a diagram showing an overview of a storage system 100 according to another exemplary embodiment.

FIG. 9 is a diagram showing a functional configuration of a storage management server 300 included in the storage system 100.

FIG. 10 is a diagram showing an example of an operation of the storage system 100.

### DETAILED DESCRIPTION

An embodiment of the present invention will be described with reference to the accompanying drawings.

A storage method according to an aspect of the present technology includes the following steps.

(a) A step in which a user uses a user terminal to perform member registration on a storage management company server operated by a storage management company, via a communication network such as the Internet and purchase a packing kit including a packing box, or to perform member registration on a service relay server operated by a company other than the storage management company and purchase a packing kit including a packing box.

(b) A step in which the user requests warehousing of an article by transmitting warehousing request information including at least a desired pickup date, type and number of packing boxes, and a designation of box storage or individual storage from the user terminal to the storage management server or the service relay server via a communication network such as the Internet.

(c) A step in which, when the warehousing request information is transmitted to the service relay server, the warehousing request information is transmitted from the service relay server to the storage management server.

(d) A step in which, after warehousing reception is complete in the storage management server, warehousing instruction information including at least a user name, address, telephone number, and client code, a type and number of packing boxes, a designation of box storage or individual storage, and a planned work day is transmitted from the storage management server to a warehouse terminal.

(e) A step in which the warehousing instruction information is transferred from the warehouse terminal to a delivery management terminal.

(f) A step in which a delivery company that has received the warehousing instruction information visits the user's home, collects an article packed in a packing box from the packing kit, and delivers it to a warehouse.

(g) A step in which, at the warehouse, the packing box is checked for external abnormalities, and thereafter image data is created by photographing the articles one by one, and each individual article is checked for abnormalities.

In a preferable aspect, the method further includes the following steps.

(h) A step in which, at the warehouse terminal, for articles with no abnormalities, article data is created by associating warehousing registration information including at least a client code, box number, article code, and stored article classification code, and the image data, and is transmitted to the storage management server, and the article is stored in the warehouse.

In yet another preferable aspect, billing is performed in units of packing kits, payment is given during the step of purchasing the packing kit, and the user is allowed to check his or her own article data at any time using the user terminal, and requests the return of a desired article among the articles from the user terminal.

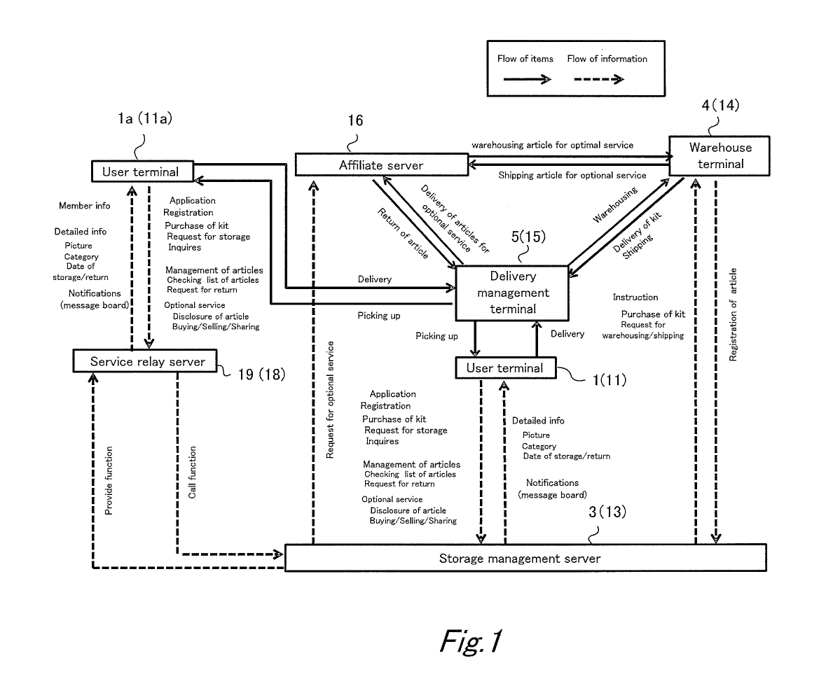

Also, the storage system according to the present invention is for carrying out the above-described method. As shown in FIG. 1, the storage system includes user terminal 1, which is used by user 11 for performing member registration on storage management server 3 via the Internet, making, to storage management server 3, a purchase request for a packing box that is a target of billing and is for packing the article, and an article warehousing request, checking the details of the user's article, and making a request to return a desired article among the articles. The storage system also includes storage management server 3, which receives and processes member registration requests, article warehousing requests, article detail check requests, and requests to return a desired article among the articles, from user 11, via the Internet. User terminal 1 is a desktop PC or a mobile terminal such as a smartphone, for example.

Also, the present system is configured to include: warehouse terminal 4, which receives the warehousing instruction information transmitted from the storage management server 3 after warehousing reception is complete and transmits it to delivery management terminal 5; delivery management terminal 5, which receives the warehousing instruction information transmitted from warehouse terminal 4; and an image capturing device such as a digital camera, which is equipped in warehouse 14, captures an image of each article, and supplies the image data thereof to warehouse terminal 4. Warehouse terminal 4 is a stationary PC or a mobile terminal such as a tablet PC that is installed in each warehouse and is operated by a worker who manages the warehouse.

The image data is transmitted to and accumulated in storage management server 3 in association with the warehousing instruction information using warehouse terminal 4, and it is made browsable upon receiving an article detail check request from user 11. Delivery management terminal 5 is a computer or computer system that keeps track of the current locations of multiple vehicles, manages a delivery schedule, and notifies drivers of information such as pickup locations or warehouse 14, which serves as the storage location. Preferably, warehouse 14 is managed by the same business as storage management company 13. The delivery company may be managed by the same business as storage management server 3, or by a different business from storage management server 3.

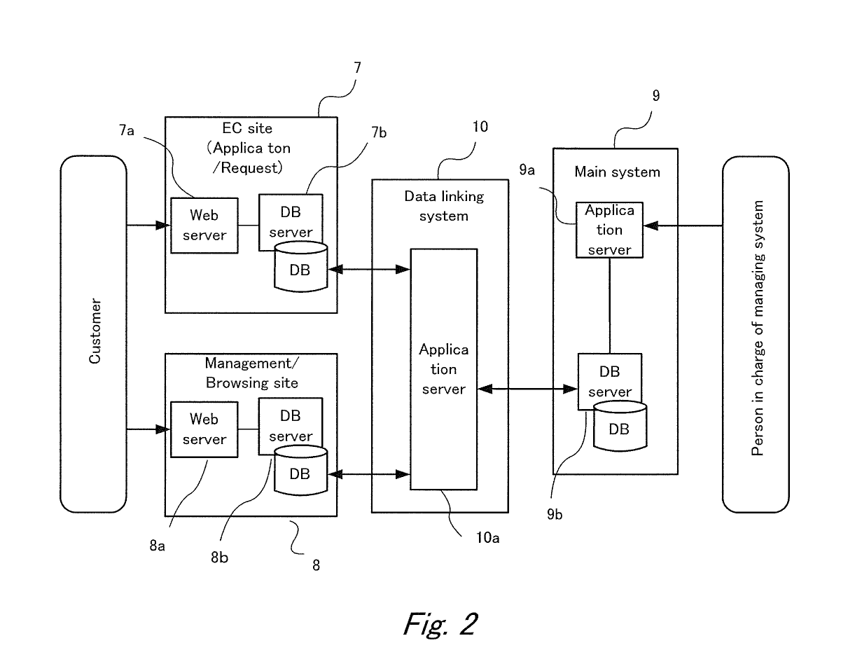

As shown in FIG. 2, storage management server 3 includes (a) EC site 7, which is provided with Web server 7a and database server 7b, and is a site used by a user to apply for member registration and make various types of usage requests, (b) Web 8, which is provided with Web server 8a and database server 8b and receives a browsing request from a user, (c) main system 9, which is provided with application server 9a and database server 9b and is used by a person in charge of the storage management company to check a user's application status and perform billing processing, and (d) data link unit 10, which is provided with application server 10a and links request information from a user to main system 9.

Service providing company 18 can provide the function of storage management server 3 to user 11a of service providing company 18 as if the system is being operated by service providing company 18. Specifically, service providing company 18 establishes a site that is to serve as a reception desk, and receives applications and requests from user terminal 1a in service relay server 19. Service relay server 19 is connected to storage management server 3, and upon receiving various types of requests (application for storage service, checking a stored article, depositing, retrieval, and the like) from user terminal 1a of user 11a on service relay server 19, service relay server 19 transmits them to storage management server 3, calls the function corresponding to the request, and provides the called function to user terminal 1a. Information about user 11a is shared between service relay server 19 and storage management server 3.

Thus, user 11a who receives the service provided by this service providing company 18 merely interacts with service relay server 19 and is not made aware of the presence of storage management company 13 in the background. Accordingly, service providing company 18 can provide the service system managed by this storage management company 13 to user 11a as if it is a system operated by service providing company 18.

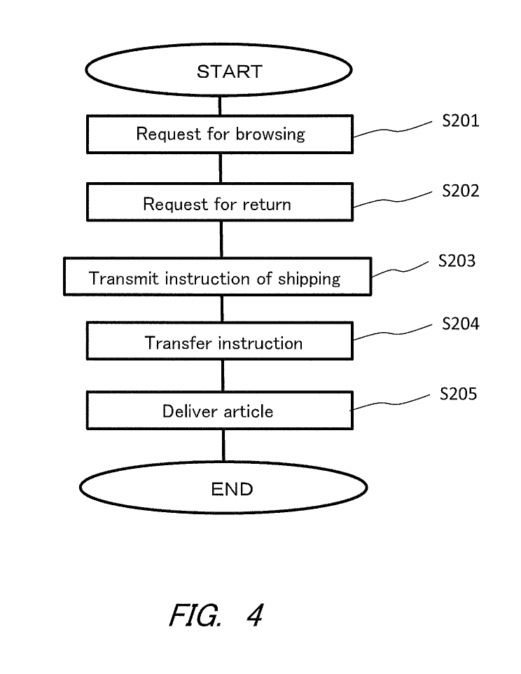

Hereinafter, a storage service function provided by storage management company 13 will be described in detail with reference to the flowcharts shown in FIGS. 3 to 5.

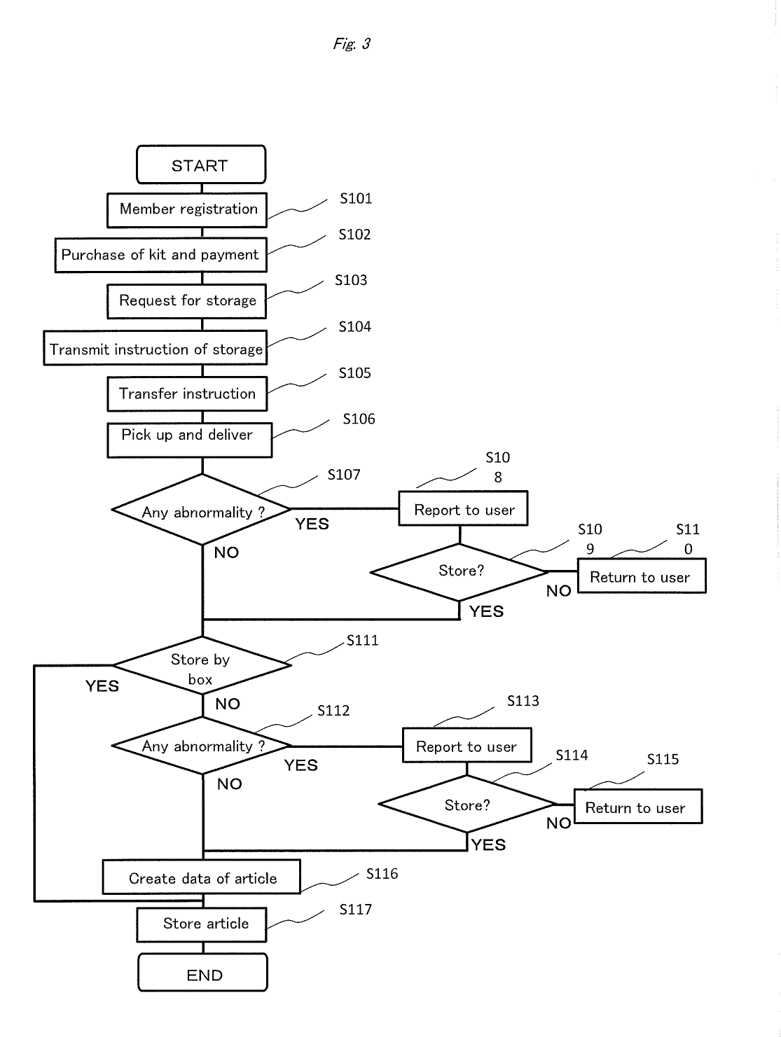

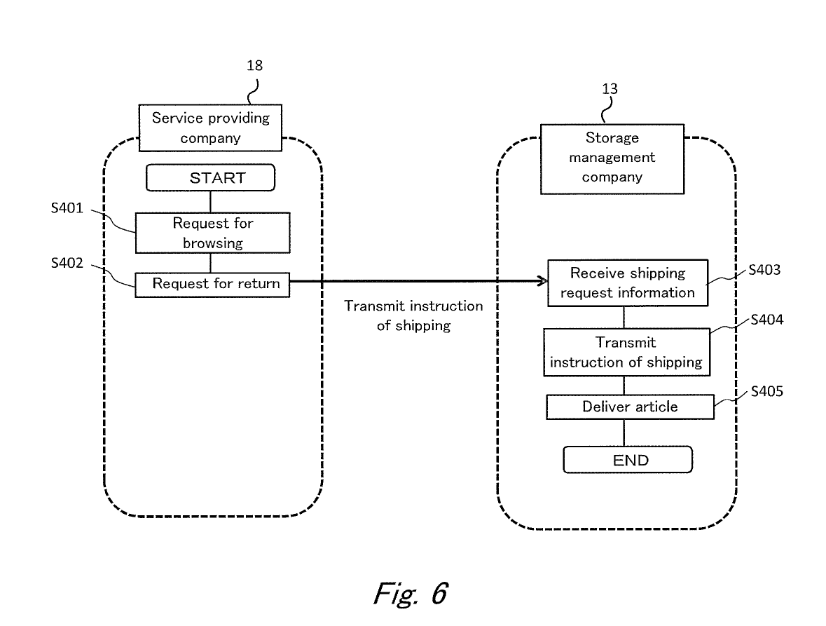

The flowchart shown in FIG. 3 shows a flow from member registration to article warehousing. The flowchart shown in FIG. 4 shows a flow from article browsing to shipping and delivery of a desired article in such a case. Also, FIG. 5 relates to a flow of a service provided by service providing company 18.

First, the flow from member registration to article warehousing will be described with reference to the flowchart shown in FIG. 3.

Member Registration Step

Using user terminal 1, which is arranged in the user's home, office, or the like, user 11 accesses storage management server 3 via a communication network such as the Internet. Then, user 11 performs member registration by inputting user information in response to a request from storage management server 3 (EC site 7), which is displayed on the screen of user terminal 1 (step S101). Accompanying member registration, an ID number for identifying the user, a password, a client code, and the like are set. Authentication of input of ID number, password, and the like is required when accessing storage management server 3 outside of the member registration step, or in other words, when using the present service, changing registered user information, making various inquiries, and the like. User information includes the user's name, address, and contact information, e-mail address, stored article pickup/delivery location, and information needed for billing processing such as credit card information.

Before making a warehousing request, user 11 transmits a packing kit purchase request to storage management server 3 (EC site 7) from user terminal 1 and acquires the needed number thereof in advance (step S102). The packing kit includes a service use guide and a packing box that accommodates one or more articles whose storage is requested at the time of the storage request. Billing is performed using one packing box as a billing unit. When a purchase request has been officially received, payment is performed in main system 9. By doing so, it is possible to make the fee schedule simpler.

Multiple types of packing boxes of different sizes may be prepared, and it is possible to make a different fee setting for each one. Here, the quantity of articles packed in one packing box has no influence on the fee. In a preferable aspect, upon receiving a kit purchase request, storage management server 3 (main system 9) transmits the kit delivery request to warehouse terminal 4, and from warehouse 14 that received the kit delivery request, a packing kit is delivered to user 11 via delivery company 15. Note that a box number for identifying the packing box is given to each packing box delivered to user 11.

Also, with the method according to the present embodiment, storage requests are received in units of packing boxes, but there are cases where articles are not taken out of a packing box and are stored still in the packed state, and cases where articles are taken out of a packing box, image data is created for each article, and the articles are stored. In a preferable aspect, a higher fee setting may be set in the case of creating image data than in the case of not creating image data.

Warehousing Request Step

Using user terminal 1, user 11 transmits an article warehousing request to storage management server 3 (EC site 7) via the Internet (step S103). Specifically, by accessing EC site 7, various selection buttons are prepared on the screen of user terminal 1, out of which a warehousing request button is selected. Accordingly, a warehousing request mode is entered, and mandatory input items (warehousing request information) including at least a desired pickup date, type and number of packing boxes, and a designation of box storage or article storage, are input, whereby the warehousing request is given.

Warehousing Instruction Information Transmission Step

When storage management server 3 (EC site 7) that has received a warehousing request performs warehousing reception, warehousing instruction information including at least the user's name, address, phone number, and client code, the type and number of packing boxes, a designation of box storage or article storage, and a desired work day is transmitted from storage management server 3 (main system 9) to warehouse terminal 4 (step S104). In a preferable aspect, exchange of data between storage management server 3 and warehouse terminal 4 is performed via the Internet.

Warehousing instruction information transfer step Warehousing instruction information received by warehouse terminal 4 is transferred from warehouse terminal 4 to delivery management terminal 5 (step S105). In a preferable aspect, exchange of data between warehouse terminal 4 and delivery management terminal 5 is performed via the Internet.

Article Collection/Delivery Step

A delivery company that has checked the warehousing instruction information that was transferred to delivery management terminal 5 visits the user's house in accordance with the warehousing instruction information, collects articles, which are packed in packing boxes by the user, in units of packing boxes, and delivers them to warehouse 14 (step S106).

External Abnormality Checking Step

In warehouse 14, at which the packing boxes have arrived, first, a worker in the warehouse or a mechanism that automatically captures images checks whether or not there is an abnormality in the exteriors of the packing boxes (step S107). If the worker discovers that there is an abnormality in the exterior of a packing box (step S107: Yes), an image of the packing box is captured by the worker, the captured image is transmitted to user terminal 1 (step S108), and an instruction of whether or not to warehouse the article in its current condition is requested (step S109). If user 11 gives an instruction to return the article without warehousing it (step S109: No), the article is returned to user 11 (step S110).

Box Storage or Individual Storage Selection Step

If there is no abnormality in the exterior (step S107: No), or if a warehousing instruction is received from the user (S109: Yes), it is determined whether user 11 has instructed storing without unpacking (box storage) or storage in which the articles are unpacked and image data is created for each article (individual storage) (step S111). If it is determined that box storage has been instructed (step S111: Yes), the articles are not unpacked and the processing moves to an article storage step (step S117), which will be described later.

Article Data Creation Step

If it is determined that individual storage has been instructed (step S111: No), unpacking is performed, and first, for each individual article, a worker checks whether or not there is an abnormality (step S112). If an article has an abnormality (step S112: Yes), image data of the article is transmitted to user terminal 1 (step S113), and user 11 is asked to give an instruction of whether or not to perform warehousing in the current state (step S114). If user 11 gives an instruction to return the article without performing warehousing (step S114: No), the article is returned to user 11 (step S115). If no article has an abnormality (step S112: No), or if a warehousing instruction is received from user terminal 1 (step S114: Yes), image data for all articles is generated (step S116). At this time, each article is given an article code (identification number) and a stored article classification code set in advance according to the type of the article, and the article code and storage article classification code are saved in association with the image data. This makes it easier to manage data and manage storage.

Article Storage Step

Excluding abnormal articles for which a non-warehousing instruction was given from user 11 (step S114: No), the image data and the articles are stored in warehouse 14 after undergoing warehousing registration in warehouse terminal 4 (step S117). After warehousing registration, warehousing registration information including at least the client code, box number, article code, and storage article classification code and the image data are transmitted from warehouse terminal 4 to main system 9. Warehousing registration information is accumulated in the database of main system 9 and is accumulated in the database of Web 8 via data link unit 10. Warehousing registration information accumulated in the database of Web 8 is provided in response to a browsing request from user 11.

Next, a flow from article browsing to shipping and delivery of a desired item will be described with reference to the flowchart shown in FIG. 4.

Browsing Request Step

User 11 transmits a browsing request from user terminal 1 to storage management server 3 (Web 8) via the Internet (step S201). After receiving the browsing request, Web 8 extracts warehousing registration information and image data of the articles for which browsing was requested from the database, outputs a list thereof, and provides it to user 11 for browsing. User 11 can give the browsing request at any time during the storage period, and can view the details of the requested articles.

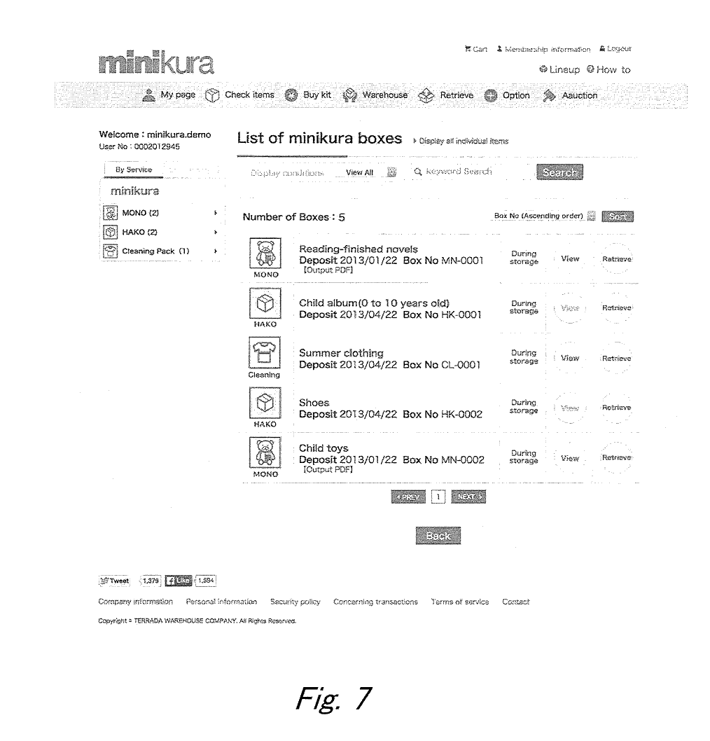

FIG. 7 shows an example of a screen displayed on user terminal 1 based on data provided to user terminal 1 in response to a browsing request. It is shown that the item displayed as “Hako” (a Japanese word meaning “box”) on the screen is a box management article in which a packing box is stored as-is in the packed state, without the contents being checked by the storage management company. It is shown that items displayed as “Mono” (a Japanese word meaning “individual article”) are individually-managed items managed individually by the storage management company creating image data of stored articles. Also, those displayed as “cleaning”, “data creation”, and “charity” indicate articles for which use of a later-described optional service has been designated.

Also, in the same screen, “view contents” and “ship” selection buttons are provided for each stored article. By clicking the “view contents” button, user 11 can view the details of stored articles using an image. By clicking the “ship” button, it is possible to request that the stored article is returned.

Return Request Step

If return of a portion or all of the articles is desired, user 11 transfers a return request from user terminal 1 to storage management server 3 (Web 8) via the Internet (step S202). As described above, the return request can be executed by clicking the “ship” button on the screen.

Shipping Instruction Information Transmission Step

Upon receiving the return request, Web 8 performs shipping reception, and thereafter shipping instruction information including at least the user's name, address, telephone number, and client code, number and type of packing boxes, a determination of box storage or individual storage, and a planned work day is transmitted from main system 9 to warehouse terminal 4 (step S203).

Shipping Instruction Information Transfer Step

Shipping instruction information received by warehouse terminal 4 is transferred from warehouse terminal 4 to delivery management terminal 5 (step S204).

Article Delivery Step

Upon checking the shipping instruction information that was transferred to delivery management terminal 5, delivery company 15 goes to warehouse 14 and picks up the individual article for which the return request was made, and delivers it to the pickup location designated by the user (home of user 11, etc.) (step S205).

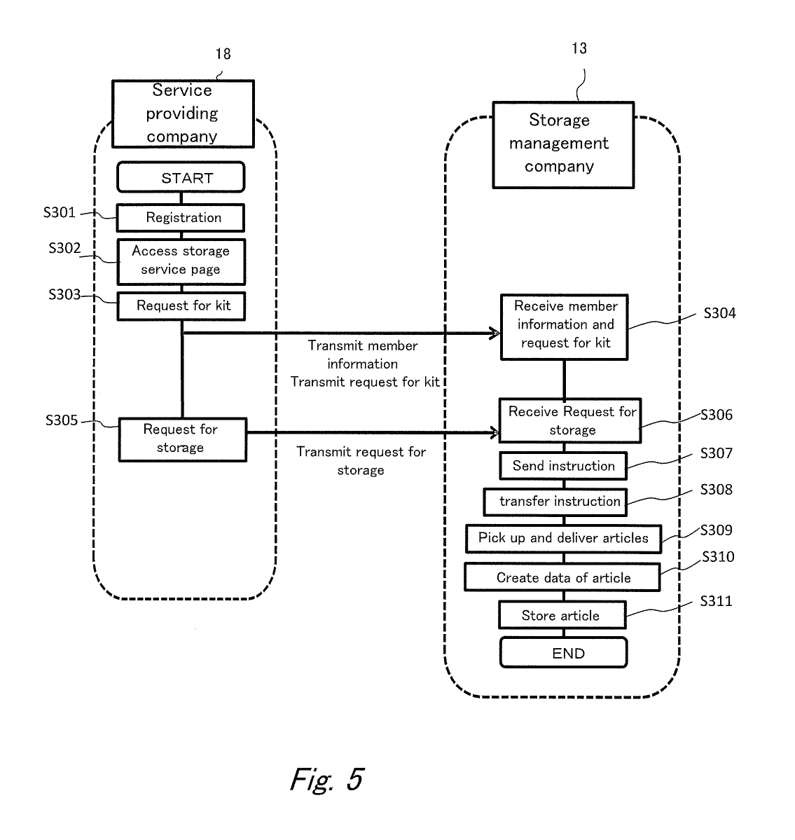

A flow of the service provided by service providing company 18, which is a corporate entity different from storage management company 13 of storage management server 3, will be described with reference to the flowcharts in FIGS. 5 and 6.

Member Registration Step (Service Relay Server)

User 11a, who is going to be provided with the service provided by service providing company 18, uses user terminal 1a installed in the user's home to access service relay server 19 via a communication network such as the Internet. Specifically, member registration is performed by inputting user information in response to a request from service relay server 19 displayed on a screen of user terminal 1a (step S301). During the member registration, an ID number identifying the user, a password, a client code, and the like are set. Authentication of the ID number, password, and the like is required when accessing service relay server 19 outside of the member registration step, or in other words, when using the present service, when changing registered user information, when making various inquiries, and the like. User information includes the user's name, address, and contact information, e-mail address, stored article pickup/delivery location, credit card, and the like. User terminal 1a is a stationary PC or a mobile terminal such as a smartphone, for example.

Before the warehousing request, user 11a accesses service relay server 19 from user terminal 1a (step S302), transmits a packing kit purchase request, and receives a desired number of packing kits (step S303). In a preferred aspect, the packing kits are the same as those used by the storage management company 13. The purchase request is transmitted to storage management server 3 along with the user's membership information (step S304). Thereafter, it is delivered to user 11a via delivery company 15, in a manner similar to that described above. Note that a box number is given to each packing box delivered to user 11a.

Warehousing Request Step

User 11a uses user terminal 1a to transmit an article warehousing request to service relay server 19 via the Internet (step S305). The warehousing request received by service relay server 19 is transmitted to storage management server 3, and thereafter, similarly to the above-described processing, the article is stored (steps S306 to S311 are the same as steps S103 to S117 above, and therefore description thereof will not be given).

Browsing Request Step

User 11a transmits a browsing request from user terminal 1a to service relay server 19 via the Internet (step S401). Upon receiving the browsing request, service relay server 19 extracts warehousing registration information and image data for the articles serving as the browsing request target from the database of storage management server 3, and transmits a list thereof to user terminal 1a. User 11a can transmit the browsing request and check the details of a requested article at any time during the storage period.

Return Request Step

If return of a portion or all of the articles is desired, user 11a transmits a return request from user terminal 1a to service relay server 19 via the Internet (step S402). The return request can be performed by clicking the “ship” button on the screen displayed on user terminal 1a. The return request received by the service relay server 19 is transmitted to storage management server 3 and thereafter the article is delivered in a flow similar to that described above (steps S403 to S405 are the same as steps S203 to S205 above, and therefore description thereof will not be included here).

In a preferable embodiment, each time processing ends, such as completion of registration, packing kit delivery, warehousing, shipping, and the like, a work completion notification may be transmitted from storage management server 3 or service relay server 19 to user terminal 1 (or 1a).

In a preferable embodiment, it is possible to classify articles according to type. For example, items such as clothes, shoes/bags, books, albums, images/musical works, home videos, hobby items, sports gear, musical instruments, watches/accessories, and sundries can be used as types for classification. This classification may correspond to the storage article classification code, but it is also possible to allow the user to freely designate it. Accordingly, it is possible to appropriately perform management for each type in accordance with the characteristics of the article. In particular, in the case of performing storage in units of boxes, it is easier for user 11 to check the contents (e.g., see “baseball gear set” in the output example shown in FIG. 7).

Storage management server 3 can provide an optional service in addition to the above-described storage service. For example, at the time of a warehousing request, user 11 (or 11a) adds information representing a desire that is held by user 11 (11a) relating to use of a stored article, such as wanting to sell, lease, or publicly disclose the article, from user terminal 1 to EC site 7. In such a case, in storage management server 3, for example, a list of articles is created for each usage mode (e.g., wanting to sell). The list may be transmitted periodically to user terminal 1 (or 1a), or may be provided in response to a request from user terminal 1 (or 1a).

Also, storage management server 3 may provide the optional service to user 11 (11a) by using a unique service provided by affiliate server 16, whose main operator is different from that of service relay server 19.

The service provided by affiliate server 16 is, for example, a service of converting books and photo albums into digital data and storing 8-millimeter tapes and VHS tapes on DVD. More specifically, user 11 (11a) is allowed to browse the digital data from user terminal 1 (1a) at any time, or user 11 (11a) is provided with a digital medium on which the data is stored while an original copy is stored.

Alternatively, affiliate server 16 may provide a service of performing discarding or disposal of an article.

Alternatively, affiliate server 16 may provide an article cleaning service. Specifically, user 11 (11a) who desires cleaning of a stored article inputs information indicating the desire for a cleaning service as the optional information in the warehousing information. Warehouse terminal 4 instructs delivery management terminal 5 to deliver the article from the warehouse to the location designated by affiliate server 16, which is operated by a cleaning company. Cleaned articles are delivered to warehouse 14 by the cleaning company and are stored in warehouse 14. At that time, notification of the fact that cleaning is complete is transmitted to user terminal 1 (1a).

Alternatively, affiliate server 16 may provide a service of using articles as exhibition items for charity or auctions. Specifically, affiliate server 16 is a server managed by a company that manages auctions, and if an article is warehoused, storage management server 3 transmits image data of the article and other information related to the article to affiliate server 16. Accordingly, affiliate server 16 is provided with information on all articles that are stored in warehouse 14 and for which auction display or the like has been designated. When affiliate server 16 performs matching processing or the like and transmits collection of a stored article to storage management server 3, storage management server 3 requests delivery management terminal 5 to transmit that article to a sending destination (e.g., the home of a successful bidder) designated by affiliate server 16 via warehouse terminal 4.

According to the present technique, detailed information including image data about individual articles whose storage has been requested can be visually checked without the user going to the storage location every time, and retrieval of a needed article can be requested at any time. Also, the fee schedule can be simplified by performing billing for packing boxes (or packing kits). In addition, various services relating to an article managed by storage management server 3 can be optionally provided to the user.

Also, the system according to the present technique is such that a service providing company that does not have the function of a storage service can provide a storage service to a user as if the storage service is being managed by the service providing company.

Also, due to service relay server 19 being connected to storage management server 3, storage management company 13 accumulates information relating to the user and the stored articles that is accumulated from service relay server 19, and can provide that information to service relay server 19. As a result, the affiliate company can use the information to improve the content of the service that the affiliate company provides.

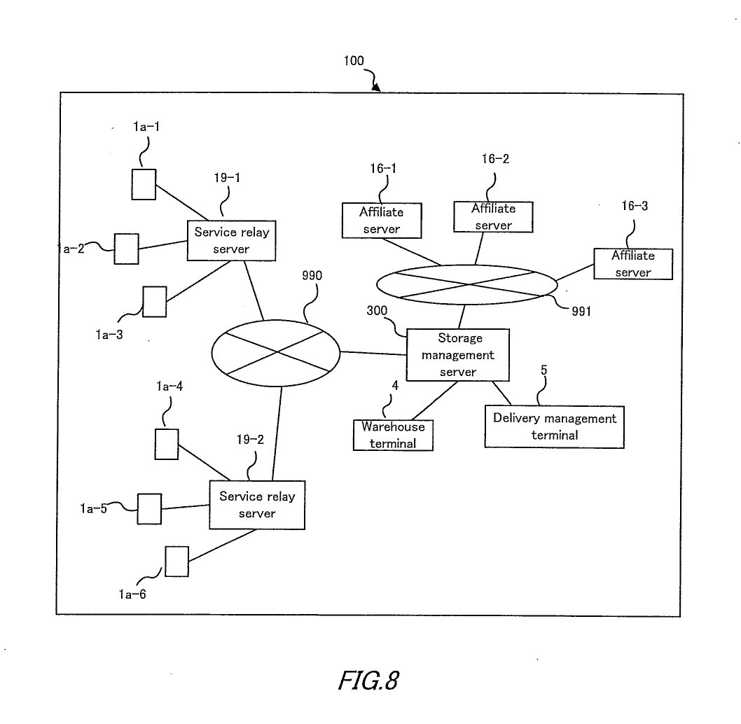

FIG. 8 is a diagram showing an outline of storage system 100 according to another embodiment of the present invention.

Storage system 100 includes storage management server 300, affiliate servers 16 (16-1, 16-2, 16-3), warehouse terminal 4, delivery management terminal 5, and service relay servers 19 (19-1, 19-2).

Service relay servers 19 are each managed by a different company, and communicate with multiple user terminals 1a (in the example shown in the drawing, service relay server 19-1 connects to user terminals 1a-1, 1a-2, and 1a-3, and service relay server 19-2 connects to user terminals 1a-4, 1a-5, and 1a-6) so as to provide services (e.g., selling of articles or provision of information) unique to each service relay server 19.

Affiliate servers 16 are each managed by a different company, and provide services using stored articles (e.g., a buying/selling mediation service, a used item buying service, a service for converting books and pictures into electronic data, a clothes cleaning service, a discarding proxy service for unwanted items, etc.).

Elements denoted by reference numerals that are the same as those in the embodiment above have similar functions thereto, and thus description thereof will not be repeated.

Storage management server 300 is a server operated by storage management company 13, which is in possession of warehouse 14. Storage management server 300 and service relay servers 19 are connected by communication network 990. Storage management server 300 and affiliate servers 16 are connected by communication network 991. Communication network 990 and communication network 991 may be the same communication network (e.g., the Internet), or they may be different. Similarly, storage management server 300 and warehouse terminal 4, and storage management server 300 and delivery management terminal 5 may be connected using dedicated lines, or they may be connected via the same network as communication network 990 or communication network 991.

Note that the number of user terminals 1a, the number of service relay servers 19, and the number of affiliate servers 16 shown in the drawing are not limited to the illustration. Also, multiple warehouse terminals 4 (warehouses 14) and delivery management terminals 5 may exist. Also, storage management server 3 and warehouse terminal 4 (or delivery management terminal 5) may be equipped as integrated hardware provided with both the function of storage management server 3 and the function of warehouse terminal 4.

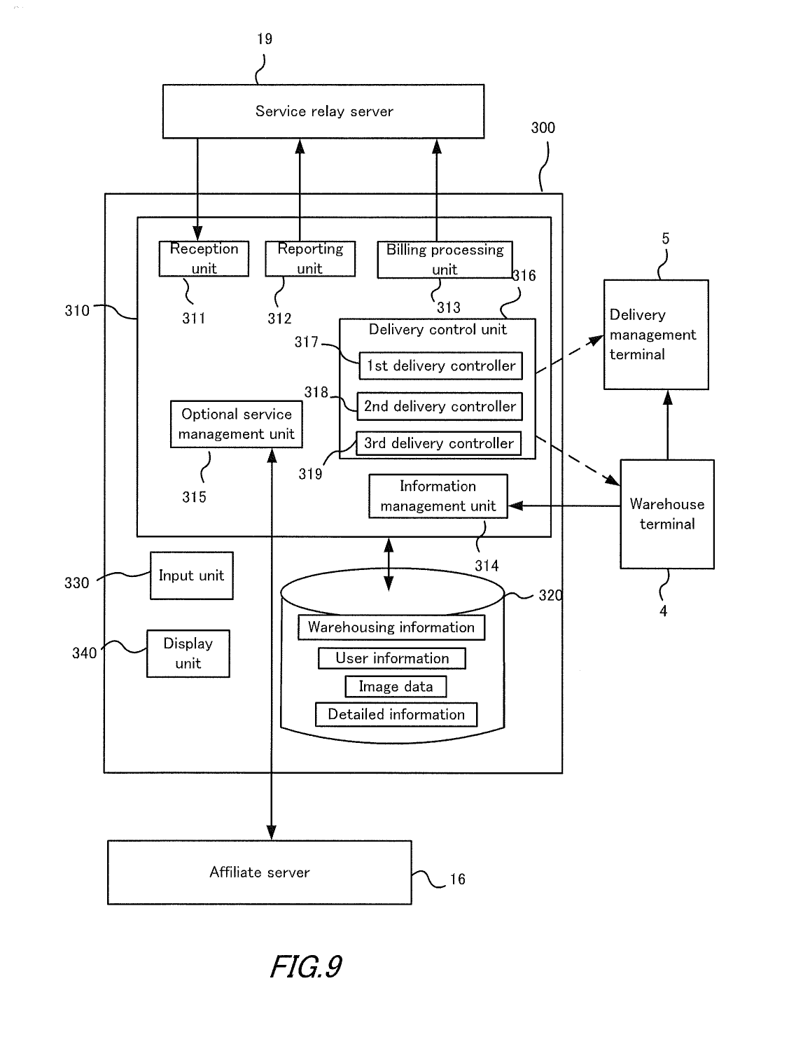

FIG. 9 is a diagram showing a functional configuration of storage management server 300. Storage management server 300 is constituted by control unit 310, storage unit 320, input unit 330, display unit 340, and a network interface (not shown) for connecting to multiple service relay servers 19, warehouse terminal 4, delivery management terminal 5, and multiple affiliate servers 16.

Storage unit 320 is a storage device such as a hard disk or semiconductor memory. In addition to programs needed for realizing later-described operations by being read out by control unit 310, the storage unit 320 stores user information for specifying a user, information needed for warehousing processing (identifiers for requesting users, identifiers for requested items and packing boxes, pickup locations, return locations, etc.), article image data, information relating to storage and delivery (product identifiers, warehousing dates, warehousing periods, current states of articles (stored/in transit to affiliate server/being prepared for shipping, etc.)), and detailed information about stored articles (information about articles, such as color, size, use, classification, state of exterior, etc.).

Input unit 330 is an input device such as a keyboard or mouse. Display unit 340 is a display device such as a liquid crystal display. Input unit 330 and display unit 340 are used so that a manager of storage management server 300 can input and check information.

Control unit 310 is realized by a processor such as a CPU. Control unit 310 includes reception unit 311, reporting unit 312, billing processing unit 313, information management unit 314, optional service management unit 315, delivery control unit 316, first delivery controller 317, second delivery controller 318, and third delivery controller 319.

Reception unit 311, reporting unit 312, and billing processing unit 313 exchange information with service relay servers 19. Reception unit 311 receives an article storage request including usage information relating to use of an article from a service relay server that receives access from a user terminal. Reporting unit 312 transmits image data and detailed information for one or multiple stored articles to service relay servers 19.

Billing processing unit 313 performs billing processing for processing of a storage request. For example, the cost of a storage request is determined based on the number of boxes assembled from the packing kit, the size of the boxes, and the period during which the boxes were stored. Also, billing processing is executed when a return request is made, or when a predetermined period has elapsed.

Information management unit 314 generates detailed information about one or more stored articles.

Optional service management unit 315 exchanges information with affiliate servers 16 in order to provide the user, who is the person requesting storage, with a service other than storage (an optional service) based on the usage information. Optional service management unit 315 requests an optional service by notifying the affiliate server corresponding to the usage information that one or multiple articles have been stored. Specifically, based on the usage information, the delivery destination (does not exist in some cases as well) of the stored information is determined out of the multiple affiliate servers, and affiliate server 16 that is the determined delivery destination is specified as the one affiliate server to which notification is to be performed. Specifically, the correspondence relationship between the usage information and affiliate server 16 is stored in storage unit 320, and the affiliate server is determined by referencing storage unit 320. For example, in the case of storing the fact that selling is desired as the usage information, a notification is transmitted to affiliate server 16 that provides the selling service.

In addition, optional service management unit 315 may transmit the image data and the detailed information to the affiliate server. Also, optional service management unit 315 and notified affiliate server 16 may perform negotiation for determining whether or not to provide the optional service, or for determining the detailed content of the optional service.

Delivery control unit 316 includes first delivery controller 317, second delivery controller 318, and third delivery controller 319, and transmits instructions to delivery management terminal 5 relating to movement of articles (including packing kits). Note that the function of delivery control unit 316 may be provided in warehouse terminal 4 instead of in storage management server 300. In such a case, instructions from storage management server 300 to delivery management terminal 5 are given via warehouse terminal 4.

First delivery controller 317 requests delivery management terminal 5 to deliver one or multiple articles packed by the user of user terminal 1a to warehouse 14. Second delivery controller 318 requests the delivery management device to return the one or multiple stored articles to the user based on the request from service relay servers 19. Before receiving the storage request, in response to the request from service relay servers 19, third delivery controller 319 requests the delivery management device to deliver a packing kit for packing the one or more articles to the user.

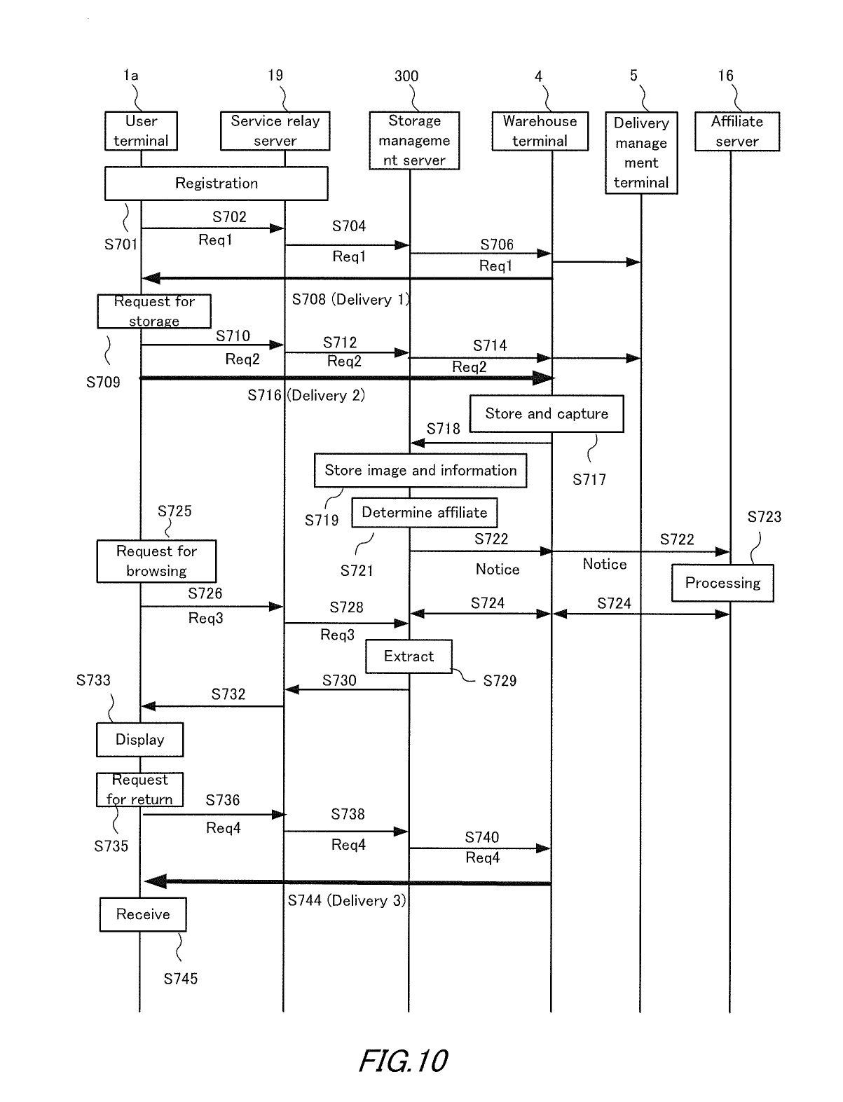

FIG. 10 is a diagram showing an example of operations of storage system 100.

User 11a of user terminal 1a performs registration needed for using service relay server 19 in advance (step S701). User information is registered in service relay server 19.

A user who wishes to be provided with an article storage service via service relay server 19 first transmits packing kit delivery request Req1 to service relay server 19 (step S702). Req1 is transmitted from service relay server 19 to storage management server 300 along with the user information (step S704). Upon receiving the user information and Req1, storage management server 300 transmits a packing kit delivery instruction to delivery management terminal 5 directly or via warehouse terminal 4 (step S706). As a result, the packing kit is delivered to the location designated by the user (step S708).

User 11a uses the packing kit to pack an article to be stored. Also, when user 11a inputs usage information and warehousing information, storage request Req2 (step S709) is generated in user terminal 1a and is transmitted to service relay server 19 (step S710). Service relay server 19 transmits Req2 to storage management server 300 (step S712).

Upon receiving Req2, storage management server 300 transmits an instruction for pickup and delivery to warehouse 14 to delivery management terminal 5 directly or via warehouse terminal 4 (step S714).

Note that the step of delivering the packing kit may be omitted. In such a case, the user performs packing with his or her own box.

When the article packed by the user using the kit arrives at warehouse 14 (step S716; Delivery 2), the storage task is performed by a worker at warehouse 14, an image of the article is captured, and image data is generated (step S717). At this time, image data may be transmitted to the user so as to prompt checking of the exterior, and it may be checked whether or not there is any change in the storage request. In this case, information indicating the checking result is input by a worker to warehouse terminal 4, and is transmitted to storage management server 300. The generated image data is transmitted to storage management server 300 (step S718). In storage management server 300, detailed information is generated based on the warehousing information and image data by the manager of storage management server 300, and is stored along with the image data in storage unit 320 (step S719).

Next, based on the usage information, storage management server 300 determines at least one affiliate server 16 serving as an affiliate destination (step S721). A predetermined notification is transmitted to the determined affiliate destination directly, or, if warehouse terminal 4 has a function of communicating with affiliate server 16, via warehouse terminal 4 (step S722).

Upon receiving the notification, affiliate server 16 executes processing in accordance with an algorithm defined in advance by affiliate server 16 (step S723). For example, a request for image data and detailed information is made to warehouse terminal 4 and storage management server 300, and based on the acquired image data and detailed information, it is determined whether or not affiliate server 16 is to apply the service to the article, and the content of the service is determined as well. If it is determined that the service is to be applied, a request for information indicating that provision of the service is to be received, and a request to deliver the product to the location designated by affiliate server 16 in order to apply the service are made to storage management server 300 directly or via warehouse terminal 4 (step S724).

If user 11a wants to check the status of storage, user 11a generates browsing request Req3 including article identification information (step S725) and transmits it to service relay server 19 (step S726). Upon receiving Req3 (step S728), storage management server 300 reads out the image data and detailed information of the article from storage unit 320 (step S729), and transmits it to service relay server 19 (step S730). Information transmitted from service relay server 19 to user terminal 1a is displayed on the screen of user terminal 1a (see steps S732, S733, and FIG. 7).

If return of a stored article is desired, user terminal 1a generates return request Req4 including the identifier for the article (step S735) and transmits it to service relay server 19 (step S736). Req4 is transferred to storage management server 300 (step S738). Storage management server 300 transmits Req4 to warehouse terminal 4 (step S744). When a worker confirms reception of Req4 at warehouse 14, a request is transmitted to delivery management terminal 5 such that the article is specified, retrieved, and delivered to the location designated by the user (step S740). As a result, the article is returned to user 11a (step S744 (Delivery 3), step S745).

According to this embodiment, the user can receive the storage service and an optional service provided by an affiliate server that is connected to the storage service by merely accessing the service providing company he or she usually uses. By contrast, a company operating affiliate server 16 can provide a service without directly interacting with user terminal 1a. In this case, it is guaranteed by storage management server 300 that an article serving as a transaction target exists, and therefore a company operating affiliate server 16 can perform transactions with ease even with a user whose identity is unknown to the company.

The present invention has been described in detail to some extent using the most preferred embodiment thereof, but it should be apparent that different embodiments can be configured without departing from the spirit and scope of the invention. Accordingly, the present invention is not limited to the specified embodiment and is only limited to the attached claims.

What is claimed is:

1. A storage method comprising:
transmitting, in response to a request from a user terminal, the first request including usage information on a usage of an article from a service relay server to a warehouse management server;
transmitting, from the warehouse management server to a delivery management device, an instruction to deliver one or more articles packed by a user to a warehouse;
generating detailed information about the one or more articles in the warehouse management server;
storing image data obtained by capturing an image of the one or more articles that have been stored, and the detailed information in the warehouse management server;
transmitting, from the service relay server to the user terminal, the image data and the detailed information acquired from the warehouse management server;
requesting an affiliate server corresponding to the usage information to provide an optional service for the one or more articles that have been stored;
in response to a request from the user terminal, requesting, by the service relay server, the warehouse management server to return the one or more articles that have been stored to the user; and
upon receiving the request, the warehouse management server requesting the delivery management device to return the one or more articles that have been stored to the user.

2. A storage management server comprising:
a reception unit configured to receive a request including usage information on a usage of an article from a service relay server accessed by a user terminal;
a first delivery controller configured to request a delivery management device to deliver one or more articles packed by a user of the user terminal to a warehouse;
an information management unit configured to generate detailed information about the one or more articles;
a storage unit that stores detailed information relating to the one or more articles that have been stored, including image data obtained by capturing an image of the one or more articles;
a notification unit configured to transmit an image and the detailed information of the one or more articles that have been stored to the service relay server;
a requesting unit configured to request an affiliate server corresponding to the usage information to provide an optional service for the one or more articles that have been stored; and
a second delivery controller configured to, based on a request from the service relay server, requesting the delivery management device to return the one or more articles that have been stored to the user.

3. The storage management server according to claim 2, wherein
the requesting unit configured to transmit the image data and the detailed information to the affiliate server.

4. The storage management server according to claim 2, further comprising
a determination unit configured to determine, out of a plurality of affiliate servers, one affiliate server to which notification is to be performed based on the usage information.

5. The storage management server according to claim 2, further comprising
a third delivery management unit configured to, in response to a request from the service relay server, requesting the delivery management device to deliver a packing kit for packing the one or more articles to the user.

6. The storage management server according to claim 2, further comprising
a billing unit configured to performing billing processing for storing the one or more articles.

7. The storage management server according to claim 5, wherein
a cost of storing the one or more articles is determined based on a number of boxes assembled from the packing kit, a size of the boxes, and a period during which the boxes are stored, and
the billing processing is executed when a return request is made or when a predetermined period has elapsed.

8. The storage management server according to claim 2, wherein
the detailed information includes information designating a classification of the one or more articles that have been stored.

9. The storage management server according to claim 2, further comprising a notifying unit configured to notify the affiliate server of at least one of a fact that storage of the one or more articles in the warehouse is complete and a fact that the one or more articles have been retrieved from the warehouse.

10. A non-tangible computer-readable medium storing a program for causing a computer to execute:
receiving a request including usage information relating to use of an article from a service relay server;
requesting a delivery management device to deliver one or more articles packed by a user to a warehouse;
generating detailed information about the one or more articles;
storing detailed information that relates to the one or more articles that have been stored and includes image data obtained by capturing an image of the one or more articles;
requesting an affiliate server corresponding to the usage information to provide an optional service for the one or more articles that have been stored;
transmitting an image and the detailed information of the one or more articles that have been stored to the service relay server;
performing notification to an affiliate server that provides a service using a stored article and is determined based on the usage information; and
requesting the delivery management device to return the one or more articles that have been stored to the user.
